(19) United States
(12) Patent Application Publication
(10) Pub. No.: US 2012/0298886 A1
(43) Pub. Date: Nov. 29, 2012

(54) FOR RAPID PROTOTYPING APPARATUS

(75) Inventors: Michael Astrup Petersen, Vigy J (DK); Niels Holm Larsen, Allschwill (CH); Ole Hangaard, Skanderborg (DK); Jèrôme Grelin, St. Louis (FR)

(73) Assignee: Huntsman International LLC, The Woodlands, TX (US)

(21) Appl. No.: 13/124,191

(22) PCT Filed: Oct. 9, 2009
(86) PCT No.: PCT/EP2009/063163

§ 371 Date: Jun. 11, 2012

(30) Foreign Application Priority Data
Oct. 17, 2008 (EP) 08018228.0
Dec. 2, 2008 (EP) PCT/EP2008/066634

(51) Int. Cl. B01J 19/12

(52) U.S. Cl. 250/492.1

(57) ABSTRACT

The present invention relates to improvements relating to a rapid prototyping apparatus for the manufacturing of three-dimensional objects by additive treatment of cross-sections.

The improvements relates to distances, a protective window, and a collision-preventing detection system.

### FIELD OF THE INVENTION

The present invention relates to improvements relating to a rapid prototyping apparatus for the manufacturing of three-dimensional objects by additive treatment of cross-sections.

### BACKGROUND

In three-dimensional rapid prototyping, it is important that the optics of the exposure system is not contaminated from contact with the light-sensitive material, which could possibly cause time-intensive cleaning or even replacement. Hence typically a relatively large distance between the output optics and the illumination area is preferred in order to avoid risk of contact between the exposure system and the light-sensitive material.

### SUMMARY

The invention relates to an apparatus for producing a three-dimensional object from a light-sensitive material, said apparatus comprising an exposure system with an illumination source, a scanning bar to which the exposure system is mounted, a control unit, whereby said exposure system comprises at least one spatial light modulator with a plurality of individually controllable light modulators, input optics optically coupled to said at least one spatial light modulator, output optics optically coupled to said at least one spatial light modulator, wherein said input optics and output optics facilitates transmission of light emitted from said illumination source via said individually controllable light modulators of said spatial light modulator to an illumination area, wherein said spatial light modulator enables an establishment of a pattern of the light transmitted through said input optics, according to control signals originating from said control unit, wherein said output optics enable focusing of the pattern of light from said at least one spatial light modulator on an illumination area, wherein the distance d between the output optics and the illumination area is between 0.5 and 20 mm.

In three-dimensional rapid prototyping, if the output optics of the exposure system is just shortly in contact with the light-sensitive material, this may cause contamination of the output optics such that the output optics needs time-intensive cleaning or even replacement. Hence typically a relatively large distance between the output optics and the illumination area is preferred in order to avoid risk of contact between the exposure system and the light-sensitive material.

With an arrangement as used in the present invention, even small inaccuracies between the directions of individual light beams may be a serious problem and may cause some voxels to deviate from the intended position. In order to lessen the troubles with alignment of multiple beams, large effort has been put into improving the alignment through modification of the design of the optics. Even though improvements have been observed this way, there is a need for even better alignment of the individual light beams.

According to the present invention it has been shown that advantageous reductions of adverse consequences of misalignment can be observed by lowering the distance between the output optics and the light-sensitive material. This is made possible through the use of output optics with characteristics such that the individual light beams focus at a suitable low distance from the part of the output optics closest to the light-sensitive material. Hereby production costs in the design of the optics may be reduced without risking the efficiency of the apparatus. The foci from the light beams together establish an illumination area, which during manufacturing will at least partly flush with the upper surface of the light-sensitive material.

Furthermore, by lessening the distance between output optics and light-sensitive material, further beneficial advantages are seen as well. A larger part of the intensity of the light is transferred to the light-sensitive material, which facilitates a faster solidification of the illuminated voxels and thus in turn facilitates a faster scanning process. Hereby a more efficient three-dimensional object manufacturing is obtained.

20 mm has been established as the largest distance where the advantageous above-mentioned results may be obtained. 0.5 mm has been established as the shortest applicable distance without having too high risk of contact with the resin.

It has been observed according to embodiments of the present invention that other means may be used to avoid contact between the exposure system and the light-sensitive material, whereby the previously feared problems with low distances need not cause that such distances are not used.

The illumination source of the present invention can emit radiation in the range from deep UV to far IR, e.g. from 200 nm to 100000 nm. The term light applies therefore to radiation in the range from deep UV to far IR, e.g. from 200 nm to 100000 nm. Applications like powder sintering of materials to produce 3 dimensional solid objects are preferably carried out in the infra red energy range with wavelength up to 10000 nm. Applications using stereolithographic baths of curable liquid resins are preferably carried out in the ultra violet energy range with wavelength from 200 nm up to 500 nm.

Moreover the invention relates to an apparatus for producing a three-dimensional object from a light-sensitive material, said apparatus comprising an exposure system with an illumination source, a scanning bar to which the exposure system is mounted, a control unit, whereby said exposure system comprises at least one spatial light modulator with a plurality of individually controllable light modulators, input optics optically coupled to said at least one spatial light modulator, output optics optically coupled to said at least one spatial light modulator, wherein said input optics and output optics facilitates transmission of light emitted from said illumination source as at least two light beams via said individually controllable light modulators of said spatial light modulator to an illumination area, wherein said spatial light modulator enables an establishment of a pattern of the light transmitted through said input optics, according to control signals originating from said control unit, wherein said output optics enable focusing of the pattern of light from said at least one spatial light modulator on an illumination area, wherein the distance d between the output optics and the illumination area is between 0.5 and 20 mm.

In an embodiment of the invention, said output optics comprises at least one micro-lens and said output optics has such characteristics that it is able to focus the pattern of light on the illumination area in such a way that the focusing distance d between the output optics and the illumination area is between 0.5 and 20 mm.

In an embodiment of the invention, said exposure system comprises at least one micro-lens adapted to focus the light in a distance d of between 1 and 10 mm, preferably between 1.5 and 5 mm from said output optics.

With micro-lenses used according to embodiments of the present invention, a suitable distance between the output optics and the illumination area is obtained.

In an embodiment of the invention, said exposure system comprises at least two micro-lenses adapted to focus the light in a distance d of between 0.5 and 20 mm, preferably between 1 and 10 mm, most preferably between 1.5 and 5 mm from said output optics.

In an embodiment of the invention, the total number of micro-lenses corresponds to at least the total number of light modulators multiplied by the number of micro-lens layers.

According to a preferred embodiment of the invention, each light-beam leaving the input optics will have its own dedicated micro-lenses and light modulator.

In an embodiment of the invention, said exposure system comprises an array of micro-lenses with the total number of micro-lenses being above 200, preferably above 600, more preferably above 2000, most preferably above 6000.

In an embodiment of the invention, said at least one micro-lens has a curvature radius between 300 μm and 400 μm.

According to the present invention it has been found that by using at least one micro-lens with a curvature radius between 300 μm and 400 μm, an ideal focusing distance from the exposure system is obtained for obtaining a suitable distance between the exposure system and the light-sensitive material for use for rapid prototyping.

In an embodiment of the invention, said at least one micro-lens has a curvature radius of between 350 μm and 390 μm, preferably between 360 μm and 375 μm.

In an embodiment of the invention, said at least one micro-lens has a curvature radius of between 310 μm and 350 μm, preferably between 320 μm and 335 μm.

In an embodiment of the invention, said exposure system comprises at least two, preferably at least three, micro-lenses with a curvature radius of between 300 μm and 400 μm.

In an embodiment of the invention, said exposure system comprises at least two micro-lenses wherein at least one of said micro-lenses has a curvature radius of between 350 μm and 390 μm, preferably between 360 μm and 375 μm and at least one other of said micro-lenses has a curvature radius of between 310 μm and 350 μm, preferably between 320 μm and 335 μm.

In a preferred embodiment of the invention three micro-lenses are used, one in a position before the light reaches the spatial light modulators and two in positions after the light passes the spatial light modulators.

In an embodiment of the invention, said at least one micro-lens has a back focal length of above 400 μm.

In a preferred embodiment of the invention three micro-lenses are used, one with a back focal length above 420 μm and two with back focal lengths of above 490 μm.

In an embodiment of the invention, said at least one micro-lens focuses the light sent through said at least one micro-lens into a beam spot with a diameter of less than 200 μm at a focusing distance from the output optics of between 0.5 mm and 20 mm.

In an embodiment of the invention, said at least one micro-lens focuses the light sent through said at least one micro-lens into a beam spot with a diameter of less than 150 μm at a focusing distance from the output optics of between 1.5 mm and 5 mm.

In an embodiment of the invention, said apparatus comprises a vat comprising light-sensitive material in an amount so that the surface of said light-sensitive material substantially coincides with said illumination area.

In an embodiment of the invention, the minimum distance between said output optics and said surface of said light-sensitive material is between 0.5 mm and 20 mm, preferably between 1 mm and 10 mm.

As previously mentioned, the exposure system may pass above the resin with a small distance when it is performing a scan to expose the surface of the resin. Due to this very small distance there is a risk of contamination of resin on the bottom surface of the exposure system during the scan across the resin surface. Such contamination may e.g. stem from parts of the built product, which during manufacturing may protrude slightly from the surface. This may e.g. be caused by the fact that a recoater accidently touches the part on the building plate, or, for some resins, that stress in the already built lower-laying layers may cause unevenness of the built surface of the previous layer. The contamination may also arise due to poor layer quality as a result of recoating for example parts including trapped volumes and large flat areas.

If the exposure system touches a protruding part the bottom surface of the exposure system will be contaminated with resin. Consequently the surface must be cleaned from resin before the exposure can be resumed, and the cleaning is a time consuming and expensive process. Furthermore there is a risk of contamination or damaging of the micro-optics and SLM-modules in the exposure system.

As a consequence there is a need to avoid or lessen contamination on the bottom surface.

Moreover the invention relates to a method of manufacturing a three-dimensional object from a light-sensitive material by use of an apparatus according to any of the claims 1-17.

In an embodiment of the invention, said method comprises the step of providing a data representation of the object.

Moreover the invention relates to an apparatus for producing a three-dimensional object from a light-sensitive material, said apparatus comprising an exposure system with an illumination source, a scanning bar to which the exposure system is mounted, a control unit, whereby said exposure system comprises at least one spatial light modulator with a plurality of individually controllable light modulators, input optics optically coupled to said at least one spatial light modulator, output optics optically coupled to said at least one spatial light modulator, wherein said input optics and output optics facilitates transmission of light emitted from said illumination source via said individually controllable light modulators of said spatial light modulator to an illumination area, wherein said spatial light modulator enables an establishment of a pattern of the light transmitted through said input optics, according to control signals originating from said control unit, wherein said output optics enable focusing of the pattern of light from said at least one spatial light modulator on an illumination area, wherein said apparatus comprises at least one releasable protective window between said output optics and said illumination area.

The present rapid prototyping apparatus is capable of illumination with multiple beams, where the multiple beams are desired to be protected and hence some kind of protection is desired. However the inclusion of a protective window in the path of the multiple beams introduces possible troublesome alignment issues as light propagating through different media will tend to lose intensity and to displace the light beams when passing the transition between different media.

Displacement of light beams due to media transitions may be problematic in any kind of rapid prototyping apparatus; however the displacement is especially problematic when a multiple beam apparatus is used in comparison to e.g. a single beam laser system, where issues concerning individual deviating displacements between different beams do not arise.

With the present invention it has been observed that troubles with the light transitions through a protective window may be avoided by moving the exposure system close to the light-sensitive material. For example it may be advantageous when the minimum distance from the output optics is less than 10 mm from the light-sensitive material.

According to embodiments of the invention, the protective window is releasable in order to facilitate an easy replacement of the protective window if the protective window has been contaminated or greased.

In an embodiment of the invention, said apparatus comprises fastening means for carrying said at least one protective window between said output optics and said illumination area.

Fastening means for carrying at least one protective window may be any fastening means suitable for the purpose. A number of different means will be known to the person skilled in the art. An example is a frame mounted on the exposure system, into which frame the at least one protective window or the replaceable module on which the at least one protective window is mounted can be inserted and thereby fixed to the system.

In an embodiment of the invention, said at least one protective window is held by said fastening means.

During use of the apparatus, the protective window or windows are held in place by the fastening means in order to give the desired protection.

In an embodiment of the invention, said at least one protective window is positioned at a distance less than 10 mm, preferably less than 5 mm, more preferably less than 2 mm from said output optics.

According to a preferred embodiment of the invention, the protective window is mounted as close as possible to the output optics in order to make the system as compact as possible.

In an embodiment of the invention, said at least one protective window is part of a replaceable module.

In a preferred embodiment of the present invention, the protective windows are gathered in replaceable modules, each containing e.g. 16 protective windows. This number could within the scope of the present invention be any number, e.g. 2, 4, 8, 9, 12 or 20. In this way the full replaceable module may be replaced if contamination has occurred on one or more of the windows. This process of replacement will typically be quicker and easier than replacing a single window.

In an embodiment of the invention, said fastening means are designed to carry said replaceable module.

Besides the above-mentioned advantage of being able to replace a whole module at once, furthermore it is advantageous that fastening means for only one element, namely the full module, is necessary on the exposure system.

In an embodiment of the invention, said at least one protective window covers more than one spatial light modulator.

In a preferred embodiment of the invention, each protective window covers 4 spatial light modulators. However in another embodiment each spatial light modulator may have its own protective window and in further other embodiments each protective window may cover e.g. 2, 3, 6, 9 spatial light modulators.

In an embodiment of the invention, the focusing distance is less than 10 mm, preferably less than 5 mm.

In an embodiment of the invention, the transmittance T in the wavelength-range of 300-400 nm of said at least one protective window is above 0.6, preferably above 0.8, most preferably above 0.9.

In an embodiment of the invention, said at least one protective window is made from fused quartz.

Several different kinds of glass may be used for the protective window; however in order to ensure a high transmission of UV-light through the window, a low amount of impurities in the glass is preferred, preferably fused quartz is used.

In an embodiment of the invention, said replaceable module is mounted on said exposure system.

In a preferred embodiment of the invention, the replaceable module containing the protective windows is mounted directly on the exposure system. Hereby a small fixed distance between the exposure system and the protective windows is ensured.

In an embodiment of the invention, the thickness of said at least one protective window is less than 4 mm, preferably less than 2 mm, most preferably less than 1 mm.

In an embodiment of the invention, said at least one protective window has dimensions of less than 100 mm×40 mm×4 mm.

Moreover the invention relates to a method of manufacturing a three-dimensional object from a light-sensitive material by use of an apparatus according to any of the claims 20-32.

In an embodiment of the invention, said method comprises the step of providing a data representation of the object.

As previously mentioned, the exposure system may pass above the resin with a small distance when it is performing a scan to expose the surface of the resin. Due to this very small distance there is a risk of contamination of resin on the bottom surface of the exposure system during the scan across the resin surface. Such contamination may e.g. stem from parts of the built product, which during manufacturing may protrude slightly from the surface. This may be caused by the fact that a recoater accidently touches the part on the building plate, or, for some resins, that stress in the already built lower-laying layers may cause unevenness of the built surface of the previous layer. The contamination may also arise due to poor layer quality as a result of recoating for example parts including trapped volumes and large flat areas.

If the exposure system touches a protruding part of resin the bottom surface of the exposure system will be contaminated with resin. Consequently the surface must be cleaned from resin before the exposure can be resumed, and the cleaning is a time consuming and expensive process. Furthermore, there is a risk of contamination or damaging of the micro-optics and SLM-modules in the exposure system.

As a consequence there is a need for methods to avoid or lessen contamination on the bottom surface and in particular to avoid collision between the exposure system and possible protrusions in the resin. Hence the present invention also relates to the following.

Moreover the invention relates to an apparatus for producing a three-dimensional object from a light-sensitive material, said apparatus comprising an exposure system with an illumination source, a scanning bar to which the exposure system is mounted, a control unit, whereby said exposure system comprises at least one spatial light modulator with a plurality of individually controllable light modulators, input optics optically coupled to said at least one spatial light modulator, output optics optically coupled to said at least one spatial light modulator, wherein said input optics and output optics facilitates transmission of light emitted from said illumination source via said individually controllable light modulators of said spatial light modulator to an illumination area, wherein said spatial light modulator enables an establishment of a pattern of the light transmitted through said input optics, according to control signals originating from said control unit, wherein said output optics enable focusing of the pattern of light from said at least one spatial light modulator on an illumination area, wherein said apparatus comprises at least one collision-preventing detection system for detecting obstacles between the illumination area and the output optics.

In three-dimensional rapid prototyping, if e.g. the output optics of the exposure system is just shortly in contact with e.g. obstacles, this may cause contamination of the output optics such that the output optics needs time-intensive cleaning or even replacement. Hence a need exists to aid in preventing contact between parts of the exposure system and obstacles, such as the light-sensitive material or protrusions from the vat.

An important feature of the present invention is that it is a collision-preventing detection system and not a collision detection system. I.e. a possible future collision is detected before it actually occurs, which means that neither the exposure system nor any other component of the apparatus is damaged or contaminated due to e.g. an obstacle protruding from the surface of the vat.

In this way, with the present invention, it is obtained that the time wasted on stoppage of the system may be highly reduced in that an obstacle protruding from the surface of the vat may be detected and removed without contaminating the apparatus as compared to prior art, where an obstacle may cause contamination of the apparatus resulting in a time-consuming cleaning process or alternatively an expensive replacement of at least a part of the elements of the apparatus.

The collision-preventing detection system according to the present invention is especially advantageous in exposure systems, where the distance between the exposure system and the surface of the light-sensitive material is kept relatively low. This means that even very small protrusions from the surface may be problematic and are important to detect in time. Examples of collision-preventing detection systems are defined in the sub-claims.

In an advantageous embodiment of the invention, the exposure system comprises a scanning bar which facilitates that the exposure system can be scanned across the surface of the light-sensitive material in order to illuminate the desired portions of said light-sensitive material.

In an embodiment of the invention, said collision-preventing detection system comprises at least one light emitter and at least one light sensor capable of providing at least one collision-preventing light beam.

According to an advantageous embodiment of the invention, the collision-preventing detection system comprises a light beam scanning the surface of the light-sensitive material in a suitable distance from the surface, i.e. 1 mm. This light beam may be emitted from a various number of illumination sources well-known to the skilled person, e.g. a laser. After crossing the relevant surface the light beam is detected by a light sensor, which is able to detect whether the intensity of the light beam drops as a result of the fact that the light beam strikes an obstacle such as a protrusion from the surface.

The beam of light is typically positioned in front of the scanning bar, but between the resin surface and the bottom surface of the scanning bar.

In a preferred embodiment of the invention, the collision-preventing detection system comprises a light emitter, a light detector, electronics to manipulate the signals and housings with means for adjusting the position and direction of the light beam.

In an embodiment of the invention, said collision-preventing detection system is capable of scanning the surface of said light-sensitive material.

According to an embodiment of the invention, the detection system comprises means for scanning the surface for possible obstacles or protrusions.

In an embodiment of the invention, the diameter of said collision-preventing light beam is less than 2 mm, preferably less than 1 mm.

Preferably the diameter of a collision-preventing light beam is kept relatively low in order to fit the distance between the exposure system and the surface of the resin. It has been observed that a diameter below 2 mm is suitable.

In an embodiment of the invention, said collision-preventing detection system comprises at least two light emitters and at least two light sensors capable of providing at least two collision-preventing light beams.

According to a further embodiment of the present invention, two light beams are used, one on each side of the scanning bar. Hereby is obtained that, no matter whether the scanning bar moves in one or the other direction, any protrusion or the like may be detected. This is advantageous in a preferred embodiment of the invention, where the exposure system scans the resin both from left to right and right to left, in which case there is a need for a collision preventing detection system on both sides of the exposure system.

In an embodiment of the invention, said collision-preventing detection system comprises a vision camera.

According to a further embodiment of the present invention, a vision camera is used as collision preventing detection system. The vision camera may be positioned in a number of different places in front of the scanning bar in the moving direction as long as it is positioned in order to monitor the surface of the light-sensitive material in front of the scanning bar to check for possible protrusions or the like.

An advantage in using a vision camera is that no part of the collision-preventing detection system is absolutely necessary directly over the surface of the light-sensitive material and it may instead be kept e.g. next to the exposure system.

In an embodiment of the invention, said at least one collision-preventing detection system is attached to said scanning bar.

In an advantageous embodiment of the invention, the collision-preventing detection system is attached to or integrated in the scanning bar, whereby the detection is carried out immediately before the scanning bar crosses the same area above the light-sensitive material.

In an embodiment of the invention, said at least one light emitter and said at least one light sensor are mounted on said exposure system.

According to a preferred embodiment of the invention, the light sensor and light emitter are both mounted directly on the exposure system. Hereby the sensor and emitter move simultaneously with the scanning bar, whereby a sensing for possible obstacles in an area of the resin surface may be carried out immediately before the exposure system reaches that area of the resin surface.

In an embodiment of the invention, said at least one light emitter and said at least one light sensor move simultaneous with said scanning bar.

In an embodiment of the invention, said at least one light sensor is electrically connected to said apparatus in order to transmit information regarding irregularities in the signal from said collision preventing light beam.

In an embodiment of the invention, said collision preventing detection system is such that said at least one collision-preventing light beam is capable of propagating between the light-sensitive material and the exposure system.

In an embodiment of the invention, said collision-preventing detection system is such that said at least one collision-preventing light beam is capable of propagating in front of and/or behind the scanning bar in a direction perpendicular to the moving direction of the scanning bar.

In an embodiment of the invention, said exposure system comprises at least two collision-preventing light beams.

With two collision-preventing light beams, detection may be carried out on both sides of the exposure system, regardless of in which direction the scanning movement is done.

In an embodiment of the invention, said at least one collision-preventing light beam is a laser beam.

In a preferred embodiment of the invention, a laser may be used to generate said collision-preventing light beam. A wavelength of any suitable value may be used.

In an embodiment of the invention, said collision-preventing detection system comprises at least one directional-changing means, such as a prism or a mirror, preferably at least two prisms and/or mirrors.

When said collision-preventing detection system comprises a light beam scanning the surface of the light-sensitive material, it is preferred to include at least two prisms or mirrors in the system as well. These prisms shaped and positioned in the right way are able to deflect the light beam of 90 degrees, which facilitates that neither the light emitter nor the light sensor is required to be close to the vat. Instead the prisms can direct the light beam(s) in the desired directions.

In an embodiment of the invention, during operation the lowest part of said exposure system is positioned less than 5 mm from the upper surface of said light-sensitive material.

According to preferred embodiments of the present invention the distance between the exposure system and the light-sensitive material is kept low in order to utilize the energy effectively and lessen the possible problems due to chromatic aberration in the lenses when using non-monochromatic light.

Moreover the invention relates to a method of manufacturing three-dimensional objects from a light-sensitive material by the use of an apparatus according to any of the claims 35-50 comprising a collision-preventing detection system.

In an embodiment of the invention, a lowering of the intensity of the signal from the collision-preventing detection system of more than 5% results in a signal stopping the movement of the scanning bar.

In an embodiment of the invention, said method comprises the step of providing a data representation of the object.

In an embodiment of the invention, said at least one collision-preventing detection system upon detecting a possible collision sends a signal which stops the movement of said exposure system.

In an embodiment of the invention, said at least one collision-preventing detection system upon detecting a risk of collision sends a signal which raises the position of said exposure system above the level of the light-sensitive material.

In an embodiment of the invention, said input optics comprises collimation optics.

In an embodiment of the invention, said output optics comprises focus optics.

In an embodiment of the invention, said exposure system comprises light-emitting diodes.

According to an aspect of the invention, the light emitting diode may be e.g. a laser diode, ultraviolet diode or any other light sources emitting light in form of electromagnetic radiation.

According to an aspect of the invention preferred light-emitting diodes used in the illumination source have a shield of e.g. a polymer, glass or plastic material, covering the light-emitting area. This shield may be used as pre-focusing and/or pre-collimating optics of the light emitted from the light-emitting area.

In an embodiment of the invention, said apparatus further comprises a vat for containing the light-sensitive material.

In an embodiment of the invention, said apparatus further comprises a building plate.

In an embodiment of the invention, said control unit further comprises means for adjusting the vertical location of said building plate relative to the output optics.

In an embodiment of the invention, said exposure system comprises more than one spatial light modulator.

In an advantageous embodiment of the invention more than one spatial light modulator is used e.g. to increase the width of the exposure system and thereby increase the illumination area to be able to build larger object or a larger number of small objects at the same time.

In an embodiment of the invention, said exposure system is built of illumination modules, wherein said illumination modules comprises at least one light-emitting diode and at least one spatial light modulator.

In an advantageous embodiment of the invention the exposure system is built of illumination modules which make the exposure system flexible. Hence customers may request an exposure system adapted to customer specific production of large or small items.

In an advantageous embodiment of the invention where the exposure system is built of illuminations modules, it may be easier or cheaper to maintain the exposure system. Only one illumination module and not the whole exposure system are to be replaced, if one spatial light modulator is damaged.

In an embodiment of the invention, said exposure system comprises more than one light-emitting diode.

According to an embodiment of the invention more than one light-emitting diode is used to increase the intensity of emitted light. With an increased intensity of light it is possible to increase the scanning speed of the exposure system across the illumination area.

In an embodiment of the invention, light from one specific light-emitting diode is illuminating one specific spatial light modulator.

According to an embodiment of the invention one specific light-emitting diode is dedicated to one specific spatial light modulator. This may be very advantageous because it then becomes possible to completely turn off one light-emitting diode if patterned light from one of the spatial light modulators does not have to be used to build one layer of an object. Turning off one light-emitting diode reduces the energy consumption as well as the generation of heat.

According to an embodiment of the invention the relationship between the light-emitting diodes and the spatial light modulators is a one to one relationship. This one to one relationship adds a high degree of flexibility e.g. enables the exposure system to turn on or off each individual spatial light modulator.

In an embodiment of the invention, said input optics comprises at least one array of micro-lenses.

According to an embodiment of the invention the input optics may at least partly be an array of micro lenses. The array of micro lenses may e.g. be used for focusing the light from the light emitting diodes into the apertures of the spatial light modulators.

According to an embodiment of the invention the input optics may comprise collimation optics for collimating the light from the light-emitting diodes. Furthermore, additional optics may be comprised in the input optics depending on the function of the input optics.

In an advantageous embodiment of the invention the input optics may comprise modules of micro lenses, hence if the exposure system comprises more than one illumination module each illumination module may be attached to one input optic module.

In an embodiment of the invention, said input optics splits the light from the light-emitting diodes into multiple beams.

According to an embodiment of the invention the multiple beams from the input optics are in a one to one relationship with the aperture of the one or more spatial light modulators. This may be very advantageous because then all light from the light emitting may be used to illuminate the light-sensitive material.

According to an embodiment of the invention the multiple beams from the input optics exceed the number of apertures of the one or more spatial light modulators. To allow more beams from the input optics than apertures of the spatial light modulators may e.g. add flexibility to the input optics because the input optics may then not fit exactly to the spatial light modulators. Furthermore additional beams from the input optics may be used e.g. to measure the intensity in the light from the light-emitting diodes.

In an embodiment of the invention, light guides guide light from said light-emitting diode to said spatial light modulator.

According to an embodiment of the invention the light-emitting diodes are physically placed at a distance from the spatial light modulators, hence it is very advantageous to use light guides such as e.g. optical fibres to guide light from the light emitting diodes to the spatial light modulators.

According to an embodiment of the invention the light guides may be part of the input optics, hence the light guides may e.g. shape, align or guide light so that it is ready to be patterned by the spatial light modulators.

In an embodiment of the invention, said apparatus facilitates that said exposure system may be scanned across said light-sensitive material.

In an advantageous embodiment of the invention the exposure system is scanned across a light-sensitive material. The spatial light modulators patterns light to cure an illumination area on the light-sensitive material, when the exposure system is scanned across the light-sensitive material. The exposure head is scanned across the light-sensitive material at least one time per layer of the object to be built.

In an embodiment of the invention, said output optics comprises at least one array of micro-lenses.

In an advantageous embodiment of the invention the patterned light from the at least one spatial light modulator is focused onto the light sensitive material by means of said array of micro lenses to ensure a uniform and precise curing of the light sensitive material.

In an advantageous embodiment of the invention the output optics may comprise modules of micro lenses, hence if the exposure system comprises more than one illumination module each illumination module may be attached to one output optic module.

Moreover the invention relates to the use of a photocurable resin in an apparatus according to claim 1-17, 20-32, 35-50, or 56-69.

Moreover the invention relates to a method of curing a photocurable composition in an apparatus according to claim 1-17, 20-32, 35-50, or 56-69.

Moreover the invention relates to a three-dimensional object produced by a method according to any of the claim 18-19 or 33-34 or 51-55.

Furthermore the invention relates to a three-dimensional object produced by use of an apparatus according to any of the claim 1-17 or 20-32 or 35-50 or 56-70.

Furthermore the invention relates to a three-dimensional object according to claims 73 and 74.

### FIGURES

The invention will now be described more in detail with reference to the figures of which

FIG. 1 illustrates a simplified cross-sectional view of a stereolithography apparatus,

FIG. 2 illustrates a part of the exposure system according to an embodiment of the invention,

FIG. 3 illustrates a cross-sectional view of part of a stereolithography apparatus comprising a collision-preventing detection system according to an embodiment of the invention,

FIG. 4 corresponds to FIG. 3 rotated 90°,

FIG. 5 illustrates a collision-preventing detection system according to an embodiment of the invention,

FIG. 6 illustrates a protective window according to an embodiment of the invention,

FIG. 7 illustrates a replaceable module comprising a protective window according to an embodiment of the invention, and

FIG. 8 illustrates a cross-sectional view of part of a stereolithography apparatus comprising a replaceable module according to an embodiment of the invention, and

FIG. 9 illustrates an example of a stereolithography apparatus according to an embodiment of the invention,

FIG. 10 illustrates a further example of a stereolithography apparatus according to an embodiment of the invention, and

FIG. 11 illustrates a further example of a stereolithography apparatus according to an embodiment of the invention.

### DETAILED DESCRIPTION

Examples of a method and an illumination unit for point illumination of a medium and how to collimate light and illuminate suitable to embodiments of the present invention can be seen e.g. from WO 98/47048, hereby incorporated by reference.

Examples of an illumination unit and a method of point illumination of a medium comprising a plurality of light emitters in the form of light guides which are arranged to illuminate at least one illumination face via a light valve arrangement suitable to embodiments of the present invention can be seen e.g. from WO 98/47042, hereby incorporated by reference.

An example of a rapid prototyping apparatus for the manufacturing of three-dimensional objects by additive treatment of cross-sections comprising a wholly or partially light-sensitive material is described in WO 00/21735, hereby incorporated by reference. This apparatus comprises at least one light source for illumination of a cross-section of the light-sensitive material by at least one spatial light modulator of individually controllable light modulators, wherein at least one light source is optically coupled with a plurality of light guides arranged with respect to the spatial light modulator arrangement in such a manner that each light guide illuminates a sub-area of the cross-section.

Within the context of this description and the appended claims, with the term “illumination area” is meant an approximated plane as defined by a number of focus points of the individual light beams originating from the output optics.

Within the context of this description and the appended claims, with the term micro-lenses is meant small lenses, generally with diameters less than one millimetre (mm).

Within the context of this description and the appended claims, with the term focusing distance d is meant the minimum distance from the output optics to the illumination area.

Within the context of this description and the appended claims, with the term light-sensitive material is meant any material sensitive to light and suitable for three-dimensional rapid prototyping. Such material will be well-known to the skilled person and could advantageously be different kinds of resin; hence the term resin and the term light-sensitive material are used interchangeably herein.

Within the context of this description and the appended claims, with the term Illumination Area is meant the cross-sectional area of the light beam at the distance, where the light beam is best focused.

Within the context of this description and the appended claims, a pattern of light can be caused by any combination of the light modulators, e.g. when all light modulators are open, a single line of light modulators are open, some individual light modulators are open or any other combination of settings of the light modulators.

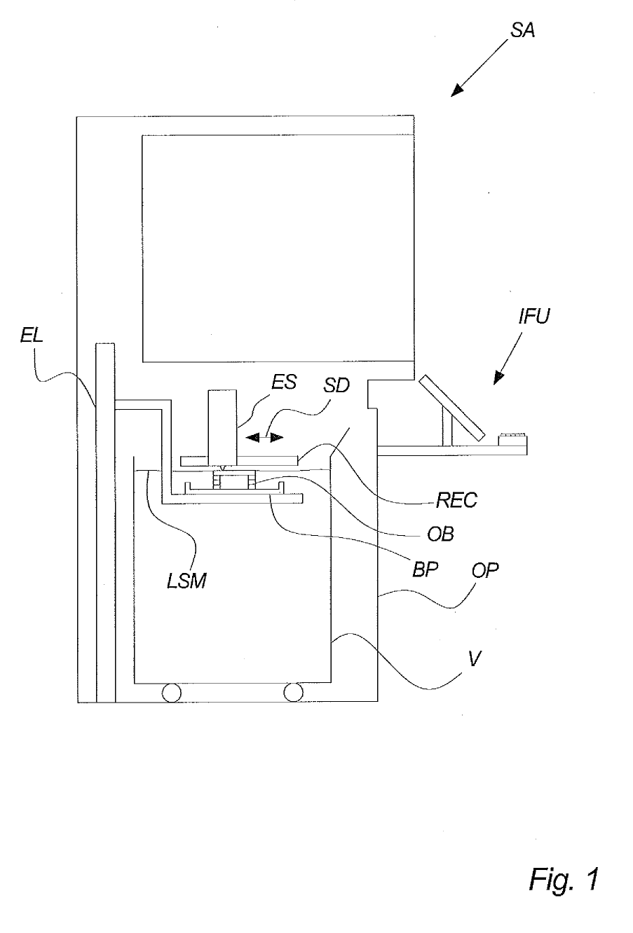

FIG. 1 illustrates a simplified cross-sectional view of a stereolithography apparatus SA for building three-dimensional objects OB according to one aspect of the present invention. The three-dimensional objects OB are built layer-wise through the curing of light sensitive material LSM when exposed to light from the exposure system ES.

The stereolithography apparatus SA comprises a building plate BP on which one or more three-dimensional objects OB is built. The building plate BP is moved vertically into a vat V comprising light-sensitive material LSM by means of an elevator EL. A recoater REC is according to an aspect of the invention scanned across the new layer of light-sensitive material LSM to ensure uniformity of the new layer. The scanning direction SD of the exposure system ES is indicated with arrows.

According to the above description the three-dimensional object OB is built by exposing a layer of light-sensitive material LSM with patterned light from the exposure system ES. The part of the light-sensitive material LSM is cured according to the pattern of light to which it is exposed. When a first layer is cured, the building plate BP with the cured first layer of the three dimensional object OB is lowered into the vat V and the recoater REC scans across the layer of light-sensitive material LSM in order to establish a fresh upper layer of light-sensitive material LSM. Then the exposure system ES is again scanned across the light-sensitive material LSM curing a new layer of the three-dimensional object OB.

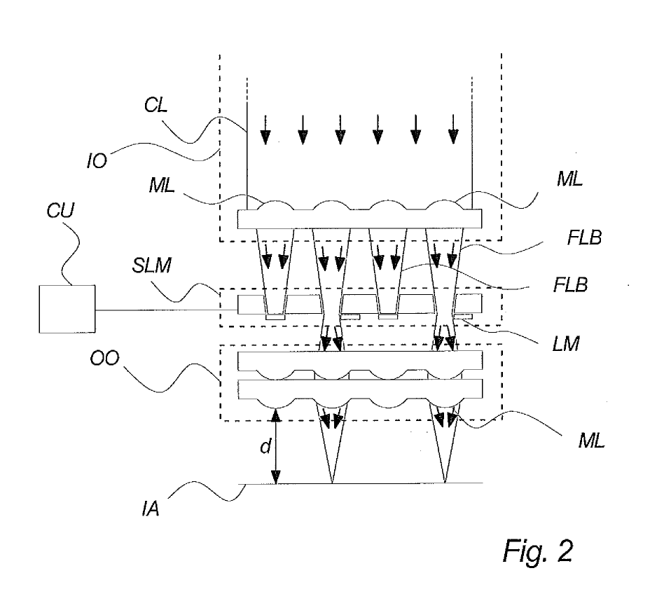

As mentioned, the stereolithography apparatus SA comprises an exposure system ES. The exposure system ES comprises an illumination source, which may be a UV-lamp, a diode, a number of diodes, or any other means of illumination source known by the skilled person suitable for the purpose of curing the light-sensitive material. Following the illumination source there are means for transforming the light from the illumination source into collimated light together with input optics IO, spatial light modulators SLM, and output optics OO. The part of the exposure system following the means of collimating the light is seen on FIG. 2.

At least part of the exposure system ES is scanned across the light-sensitive material LSM in a scanning direction SD, illuminating an illumination area IA on the surface of the light-sensitive material LSM according to a digital layer-wise representation of the three-dimensional object OB. According to an aspect of the invention, the exposure system ES is curing the light-sensitive material LSM in the illumination area IA, thereby forming the three-dimensional object OB.

In an aspect of the invention, the vat V may be equipped with means for moving the vat V such as wheels, interactions with a rail, track, forklifts etc. Hence the vat V may be removably located in the stereolithography apparatus SA e.g. accessible via an opening OP to refill the vat V with light-sensitive material LSM or to easy removal of three-dimensional objects OB from the building plate BP.

It should be noted that it is possible, e.g. by means of the illustrated elevator EL or other devices, to move the vat V vertically instead of moving the building plate BP.

The digital layer-wise representation of the three-dimensional object OB may, according to an aspect of the invention, be provided to the stereolithography apparatus SA via an interface unit IFU. The interface unit IFU may comprise input interfaces, such as e.g. a keyboard or pointer and output interfaces such as e.g. a screen or a printer, to handle communication via interfaces such as e.g. LAN (LAN; Local Area Network), WLAN (WLAN; Wireless Local Area Network), serial communication etc. Furthermore the interface unit IFU may comprise data processors, memory's and/or means for permanent storing of data.

FIG. 2 illustrates a simplified cross-sectional view of the part of the exposure system following the means of collimating the light according to an aspect of the invention.

According to one aspect of the invention, in order to transmit light from the illumination source to at least part of the light modulators LM of the at least one spatial light modulator SLM, light guides are used between the means for collimation and the input optics IO. In another aspect of the invention, which may be combined with the other, light guides are used between the illumination source and the means for collimation. Such light guides may e.g. comprise optical fibres (e.g. made of polymer, plastic, glass etc.), optics, lens arrays, reflectors, etc.

The light-sensitive material LSM may according to an aspect of the invention be a determining factor for the choice of illumination source. Typically the light-sensitive material LSM is cured when exposed or illuminated with light of high intensity within wavelengths between 200-500 nm. Typically light with a wavelength peaks between 300 and 400 nm are the most optimal for curing the preferred type of light-sensitive material LSM. Of course light with other than the mentioned wavelengths may be used if special light-sensitive material LSM is required.

It should be noted that the light-sensitive material LSM is also cured when it is exposed to a broad-spectrum light e.g. from the general illumination distribution of a room, because the general illumination distribution of a room often also contains light with wavelengths on which the light-sensitive material LSM reacts. Curing of light-sensitive material LSM from such stray light is not desirable because it is slow and not controllable.

The intensity of the light emitted from the illumination source may according to an aspect of the invention vary. The higher the intensity, the shorter the time the light-sensitive material LSM has to be exposed to the light to cure. Hereby the speed of the exposure system ES scanning over the light-sensitive material LSM may be faster. Of course other factors are also determining for the scanning speed such as the type of light-sensitive material LSM, response time in the spatial light modulators SLM, etc.

According to an aspect of the invention, the exposure system comprises input optics IO, at least one spatial light modulator SLM and output optics OO. Hence light from the illumination source are, by means of the input optics IO, at least partly collimated and focused onto at least some of the apertures of the at least one spatial light modulator SLM. The at least one spatial light modulator SLM then establishes a pattern of light onto the output optics OO, which again focuses the patterned light on the illumination area IA on the light-sensitive material LSM.

It should be noted that a pattern of light also includes the situation when all individual light modulators LM of the spatial light modulator SLM are in a position which either lets light through all apertures of the spatial light modulator SLM or does not let any light at all through the apertures of the spatial light modulator SLM.

The stereolithography apparatus SA does according to a preferred aspect of the invention comprise more than 48 spatial light modulators SLM. It should be noted that the stereolithography apparatus SA according to an aspect of the invention is very flexible in relation to the number of spatial light modulators SLM. Hence the number of spatial light modulators SLM may vary between 1 and e.g. up to more than 100.

According to an aspect of the invention, the individual spatial light modulators SLM may be combined in modules of four. Hence, according to a preferred aspect of the invention, when more than four spatial light modulators SLM are needed, more than one module are combined together forming the exposure system ES.

Each spatial light modulator SLM comprises according to an aspect of the invention more than 500 individually controllable light modulators LM. Of course spatial light modulators SLM with a number which differs, sometimes differs a lot, from the 500 individually controllable light modulators LM may be used. To simplify the figures, throughout this description the figures only illustrate the spatial light modulators SLM with e.g. four light modulators even though, as mentioned, there may be more than 500.

The input optics IO may according to an aspect of the invention and as shown in FIG. 2 comprise a micro lens array. In further embodiments further micro lenses may be included in the input optics as well as other optical elements.

A purpose of the input optics is to focus the collimated light CL onto the at least one spatial light modulator SLM. As explained below, the at least one spatial light modulator SLM comprises a plurality of apertures and it is onto or down through these apertures that the micro lenses ML are focusing the collimated light CL.

The at least one spatial light modulator SLM may according to an aspect of the invention be used to pattern the collimated and focused light onto illumination areas IA on the light sensitive material LSM. The at least one spatial light modulator SLM comprises a plurality of individual light modulators LM also referred to as light switches, light valves, micro shutters etc.

According to an aspect of the invention, the individual controllable light modulators LM are controlled by a control unit CU. The control unit CU may control the exposure system ES according to the digital layer-wise representation of the three-dimensional object to be built. The illustrated control unit CU may control the individual controllable light modulators LM of the at least one spatial light modulator SLM and in the case of individual light-emitting diodes LD, these may also be controlled by the control unit CU.

According to an aspect of the invention where light-emitting diodes LD are used, controlling the light-emitting diodes LD means to turn the light-emitting diodes LD off if e.g. only a small part of an object or a small object is to be built, which does not require patterned light from the at least one spatial light modulator SLM included in the exposure system ES.

According to an aspect of the invention, the controlling of the light modulators LM in the at least one spatial light modulators SLM may be done by addressing the light modulators LM according to the pattern. The pattern may represent one layer of the three dimensional object to be built.

In an embodiment of the invention, the illustrated control unit CU may also control other part of the stereolithography apparatus SA than the exposure system ES. Alternatively the control unit CU may be included in other control systems in relation to the stereolithography apparatus SA.

The stereolithography apparatus SA may according to an aspect of the invention be provided with digital layer-wise descriptions of the three-dimensional object to be built. The layer-wise description of the three-dimensional object may include support structure if the three-dimensional object requires support during the building process. For each layer of the three-dimensional object, the exposure system ES is scanned across the light-sensitive material LSM and the individual digital layer-wise description of the three-dimensional object determines the pattern of light from the spatial light modulator SLM.

According to an aspect of the invention the output optics OO focuses the patterned light from the spatial light modulator SLM onto one or more illumination areas IA on the surface of the light-sensitive material LSM. Like the input optics IO, the output optics OO may comprise more than one lens system e.g. more than one array of micro lenses ML.

A preferred embodiment of part of an exposure system is shown in FIG. 2. Collimated light CL is sent through a first micro lens array as part of the input optics IO, which works to focus the collimated light CL into a number of focused light beams FLB suitable for entering each individual shutter on the light modulators LM. For each open light modulator LM the light will pass and spread out again after having passed the light modulator LM. In this shown embodiment, the output optics OO comprises two micro-lens arrays in immediate continuation of each other to focus the light, whereby desired light spots of a diameter of approximately 100 μm are obtained on a focal plane, the illumination area IA, at a distance d of approximately 2-3 mm.

In the shown embodiment this highly advantageous focusing of the light in the desired distance has been obtained by using the above-mentioned two micro-lens arrays in immediate continuation to each other with suitable parameters, namely a curvature radius of 365 μm and a back focal length of 499 μm. Together with the use of a single micro-lens array in the input optics with a curvature radius of 328.5 μm and a back focal length of 425 μm, this combination has proven to provide a highly advantageous combination of optics in the exposure system. However, further optical elements with values of these parameters in a range around such found values have also shown to provide advantageous results.

In this embodiment the used micro-lenses are part of an array comprising a number of lenses manufactured in one piece. Obviously within the scope of the invention, it would be possible to manufacture and insert individual lenses for each individual shutter, or any number of lenses other than the one shown may be combined together on one micro lens plate.

It should be clear that the embodiment shown in FIG. 2 is shown solely as an example and suitable embodiments may be obtained by replacing one or more of the micro-lens arrays.

Back focal length and curvature radius are terms well-known to the skilled person; however for sake of clarity these are defined as follows.

A spherical lens has a center of curvature located in (x, y, z) either along or decentered from the system local optical axis. The vertex of the lens surface is located on the local optical axis. The distance from the vertex to the center of curvature is the curvature radius of the lens.

Back focal length (BFL) is the distance from the vertex of the last optical surface of the system to the rear focal point.

With the present invention has been obtained that contamination of the exposure system can be prevented or at least kept at a minimum degree by the use of one or more protective windows.

FIG. 6 shows an example of a protective window PW according to an embodiment of the invention.

FIG. 7 shows an example of a replaceable module RM according to an embodiment of the invention. The shown replaceable module RM comprises 16 protective windows PW; however this number may be any other suitable number according to various other embodiments of the invention. In the shown embodiment the individual protective windows PW are mutually evenly displaced in order for the SLMs below the protective windows PW to cover the full width of the scanning area. Obviously these protective windows PW may be differently distributed depending on different parameters such as the size of the scanning area etc.

FIG. 8 shows an exposure system ES on which a replaceable module RM comprising protective windows PW is mounted in fastening means FM for holding the replaceable module RM. In the shown embodiment these fastening means FM are simply rails on each side of the exposure system ES.

In another advantageous embodiment the fastening means FM is a system where the replaceable module RM can be pushed into a recess and then snapped into a fixed position.

However, a number of different suitable fastening means will be apparent for the skilled person.

A protrusion PR is shown in FIG. 8, which in the shown case may be a bubble in the upper surface US of the resin LSM. Such a bubble is an example of a protrusion PR which for most resin types will very seldom occur. However, if it turns up, this may happen quite suddenly, whereby a possible detection system mounted elsewhere on the apparatus, although effective, might not be sufficient.

With the protective window(s) PW such a bubble may leave small amounts of resin on the protective window(s), but the optics is left undamaged and uncontaminated. Hereby the relatively simple process of replacing the replaceable module RM is sufficient for being able to start the apparatus again following the occurrence of such a bubble.

Another example of a cause of a protrusion is that the curing of the resin may cause a little shrinkage. Such shrinkage may cause that uncured resin LSM surrounding the cured area is pushed up a little above the level of the surrounding resin. In this way such resin may be brought closer to or even into contact with the exposure system ES.

With the present invention a sensor has been obtained to detect obstacles between an exposure system and the resin in additive manufacturing in order to prevent contamination of the exposure system and to prevent damage on the built part.

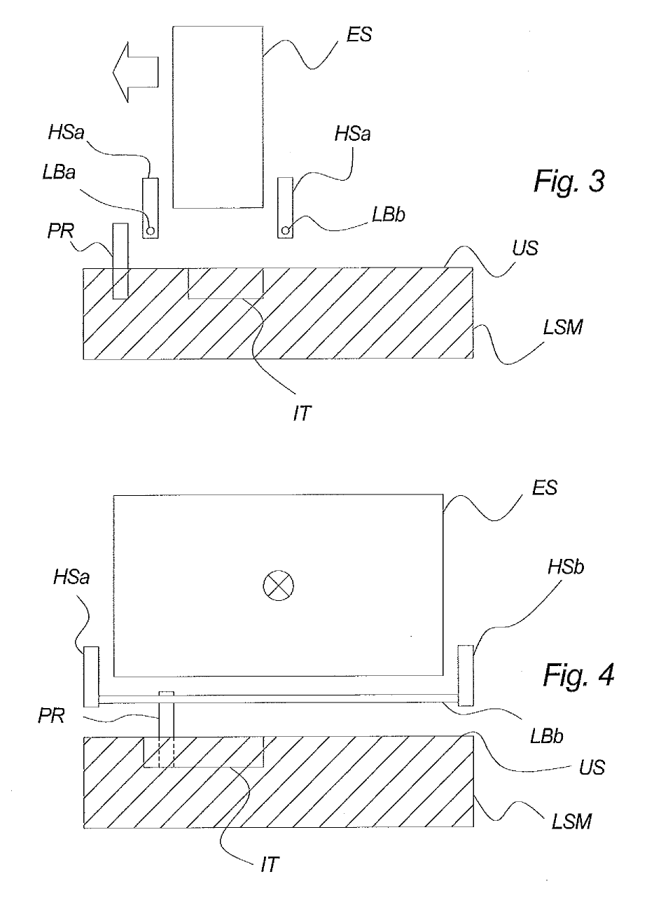

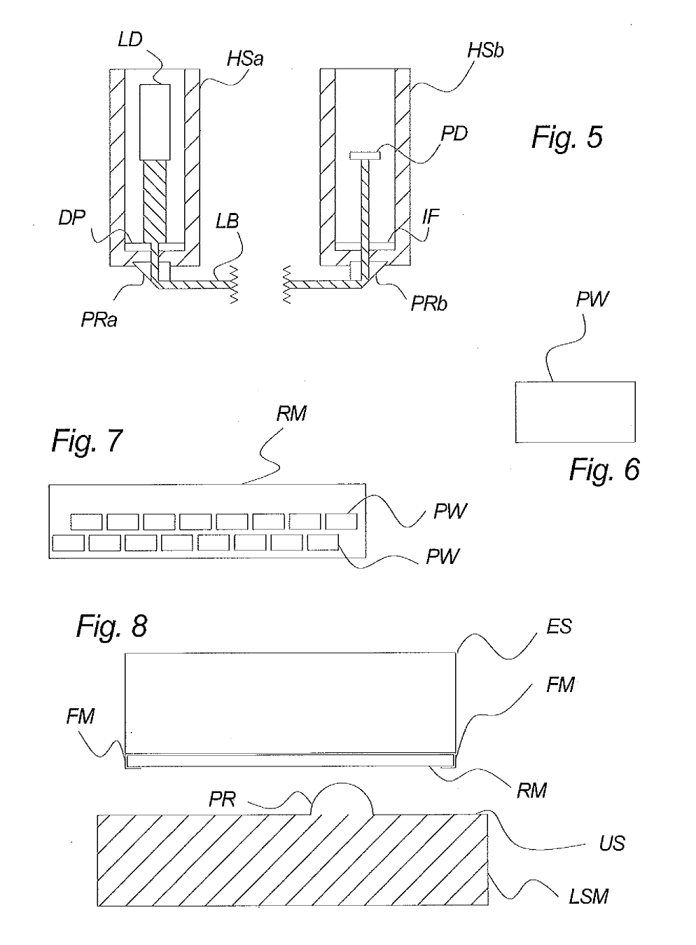

FIG. 3 shows the main parts of the exposure system ES with the exposure system ES moving to the left towards a protrusion PR protruding from the otherwise planar surface of the vat V containing light-sensitive material LSM. In the vat V is moreover shown a part of an item IT maintaining its upper surface as intended, namely essentially flush with the upper surface US of the light-sensitive material LSM. In the shown embodiment the collision-preventing detection system comprises two laser beams LBa and LBb emitted from housings HSa, which is described more in detail with reference to FIG. 5. It is noted that in the shown embodiment two laser beams LBa and LBb are positioned on the sides of the exposure system ES in order to be able to detect protrusions no-matter whether the exposure system ES moves to the left or to the right in the shown embodiment. However, in further embodiments of the invention, only one laser beam may be used or even more than two.

FIG. 4 shows the same setting as in fig. in a 90° rotated view, i.e. the exposure system ES moves away from the viewer towards the protrusion PR. Hereby one of the laser beams LSb can be seen extending below the total width of the exposure system ES from a light-emitting housing HSa to a light-sensing housing HSb. Is it noted that the shown laser beam will be the one to the rear of the moving direction, whereas the one in the front of the moving direction cannot be seen in the figure as it is positioned behind the rear laser beam which is also indicated FIG. 3.

From the figure can be seen that the front laser beam LBa, positioned in the figure behind the laser beam LSb, will reach the protrusion PR at some stage during the movement and thereby the laser beam LBa will be interrupted by the protrusion PR resulting in a decreased light intensity reaching the light sensing housing HSb. Hereby it can be concluded that a protrusion PR is present in front of the exposure system ES which may be a risk for contamination of the exposure system. A signal can then be sent resulting for instance in a stop of the apparatus in order for operation staff to solve the problem. In this way the protrusion may be easily removed or lowered and the apparatus may be started again maybe a few minutes later. In case the protrusion PR gets into contact with the exposure system ES a cleaning or replacing process may be necessary resulting in extensive time consumption and costs.

The important elements to make the invention work are the size of the parts in the sensor. As the distance between the bottom surface of the exposure system and the surface of the resin typically is as small as 2 mm, the parts that produce the light beam must be small and made with small tolerances. If the width of the scanning bar as an example is 670 mm, this will also set a lower limit for the distance between emitter and sensor, which will typically be just above this value. Assuming that half the distance between the bottom surface of the exposure system and the resin can be acceptable for the angular misalignment, the angular misalignment must be less than 0.08°. Assuming that half of the distance between the bottom surface of the exposure system and the resin surface can be used for the diameter of the beam, the beam size must be less than 1 mm. Hereby it may be avoided that the receiver will see two sources, one real source from the emitter and one reflection from the resin surface.

This gives the requirements for the optical parts in the emitter and the sensor and also the requirement to the means used for the micro adjustment of the alignment.

FIG. 5 gives an example of the design of the optical parts, where the two different housings HSa and HSb are shown. Typically the front and the rear set will be the same, hence only one set is shown here.

In this example a laser diode LD emits a laser beam LB which is shaped through a diaphragm DP before it is reflected in a prism PRa through a 90° angle whereby the beam is directed to be flush just above the surface of the resin. Having passed above the surface US of the resin LSM below the exposure system ES, the beam LB is reflected in a second prism PRb and directed into the light-sensing housing HSb. Before reaching the photo diode PD in this housing, the light beam LB passes through an interference filter IF to avoid that e.g. stray light can interfere with the measurement of the photo diode PD.

The use of prisms PRa and PRb is aimed at obtaining a compact design and to avoid that either the laser diode LD or the photo diode PD need to be close to the surface US of the resin LSM. Obviously angles other than 90° may also be used within the scope of the present invention.

A prism can be used both as an internal or an external reflector; in the embodiment shown in FIG. 5 the prisms are used as internal reflectors.

An advantage of using prisms as internal reflectors is that the surfaces of the prism can be made flush with the housing and thus give better cleaning possibilities. To protect the fragile edge of the prism, the edge may simply be cut off as shown in FIG. 5, which allows for the use of clipped beams, whereby parts of the light beam hitting the part cut off will not be essentially bent; this will not produce any risk of stray light beams from the laser between the emitter and the sensor with a risk of impacting the resin. Hereby, without risk of disturbing stray light, the light beam may be moved as close as possible to the surface of the resin, i.e. to the right in FIG. 5. This method may also be used in the external reflection embodiment.

In an advantageous embodiment of the invention the apparatus comprises a restart-button, whereby the apparatus upon an interruption of the laser beam LBa resulting in a stoppage of the apparatus can quickly continue the manufacturing process. This is e.g. advantageous if the interruption was caused by a bubble in the resin or the like, whereby the problem may be solved when the operator comes to the machine.

In an advantageous embodiment of the invention the exposure system comprises modules of spatial light modulators (SLM), wherein each module comprises more than one spatial light modulator.

In an advantageous embodiment of the invention the input optics is made of modules, hence one input optics module corresponds to one module of spatial light modulators.

In an advantageous embodiment of the invention the output optics is made of modules, hence one output optics module corresponds to one module of spatial light modulators. The modular structure of the exposure system, the input optics and the output optics facilitates easy modification of the exposure system e.g. to meet specific user defined requests for the size of the illuminations system.

In an advantageous embodiment of the invention the input and output optics are made of modules, hence one input and one output optic module corresponds to one spatial light modulator.

In an advantageous embodiment of the invention the light modulators of the spatial light modulator pattern the light from the illumination source. The light-sensitive material is cured in a pattern in dependence on the position of the light modulators in the spatial light modulator.

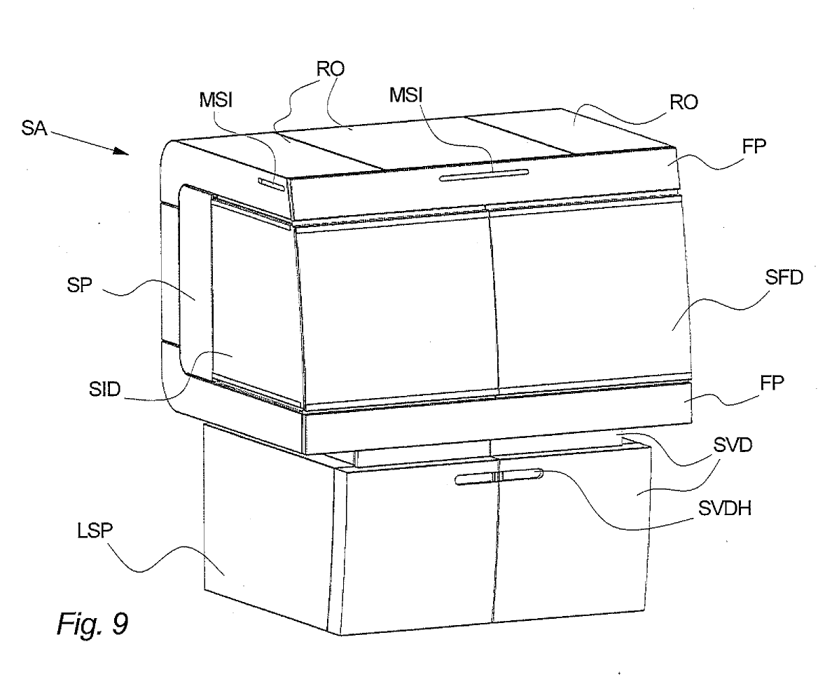

FIG. 9-11 illustrates only one possible embodiment of the stereolithography apparatus SA, it should be noted that not all below mentioned features are necessary for the stereolithography apparatus SA to operate. Furthermore it should be noted that not all details of the stereolithography apparatus SA are illustrated and that additional, not illustrated, parts may be advantageous.

FIG. 9 illustrates the stereolithography apparatus SA in a front/side view according to an aspect of the invention.

The stereolithography apparatus SA may be equipped with one or more sliding vat doors SVD, which may e.g. be opened by means of a sliding vat door handle SVDH, which is operated e.g. by pushing, turning, etc. The sliding vat door SVD may give access to the vat V (not shown) by means of sliding to one side or by means of pivoting around one or more hinges.

One or more sliding front doors SFD may be positioned in relation to one or more front panels FP and side panels SP.

The sliding front door SFD may give access to the exposure system ES (not shown) by means of sliding to one side or by means of pivoting around one or more hinges.

It should be noted that the sliding front doors SFD may be transparent so that the building process can be monitored without opening the sliding front door SFD.

The one or more front panels FP may extend to the side of the stereolithography apparatus SA. The one or more front panels FP may be equipped with one or more machine status indicators MSI, indicating the status (e.g. in operation, stopped, fault, etc.) of the machine or at which stage of a building process the stereolithography apparatus SA is at a given time. The machine status indicator MSI may also be located on the roof RO or side of the stereolithography apparatus SA and it may e.g. comprise a display, lamps, sirens etc.

Furthermore the stereolithography apparatus SA may be equipped with one or more side doors SID and one or more lower side panel LSP, which are not in use under normal operation of the stereolithography apparatus SA. The side doors SID and the lower side panel LSP are only dismounted or opened when parts of the stereolithography apparatus SA are to be maintained.

It should be noted that the side doors SID may according to an aspect of the invention be part of the sliding front door SFD and the lower side panel LSP may according to an aspect of the invention be part of the sliding vat door SVD.

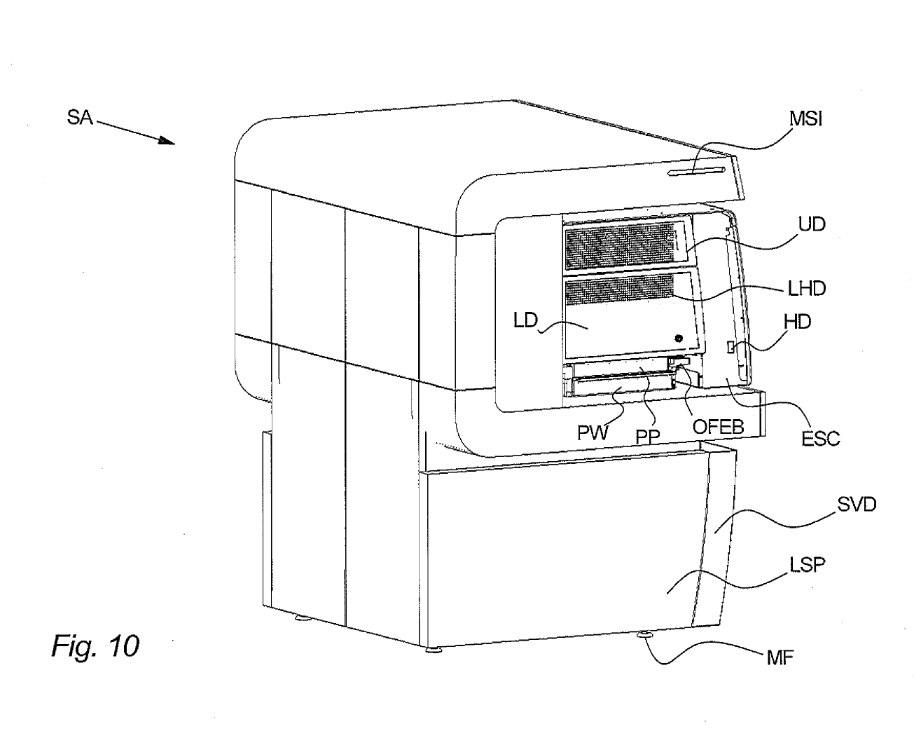

FIG. 10 illustrates the stereolithography apparatus SA in a back/side view according to an aspect of the invention, where the side door SID and the sliding front door SFD are dismounted revealing the exposure system ES.

The stereolithography apparatus SA may according to an aspect of the invention stand on one or more machine feet MF, which may be adjustable. This may make easier installing the stereolithography apparatus SA, so that when the vat V (not shown) is located into the stereolithography apparatus SA the surface of the light-sensitive material LSM and the output optics OP (not shown) are substantially parallel.

The illustrated exposure system ES comprises an upper left side door UD and a lower left side door LD used when maintaining or servicing the exposure system ES. Furthermore, the exposure system comprises a lamp housing door LHD for accessing the illumination source IS (not shown). Furthermore the exposure system ES comprises a protection plate PP for protecting the different parts of the illumination unit IU (not shown). The side of the protection window PW is also illustrated on FIG. 10 together with the outer frame of the exposure bar OFEB

A handle HD for releasing the protection window PW (not shown) may be located in the exposure system casing ESC.

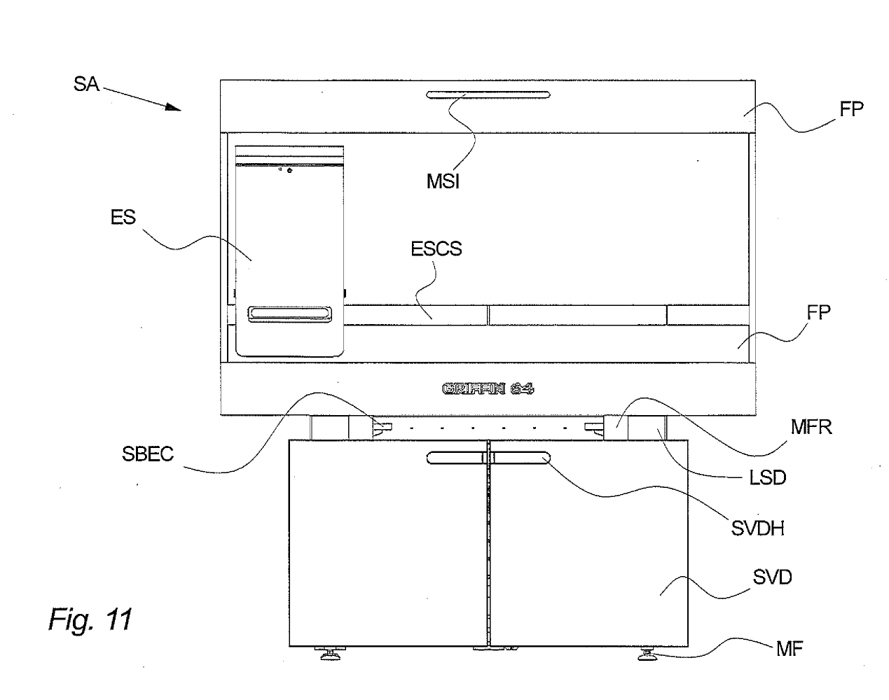

FIG. 11 illustrates the stereolithography apparatus SA in a front view according to an aspect of the invention, where the sliding front door SFD is removed. The exposure system ES is moving in a exposure system carriage slit ESCS, when scanning across the light-sensitive material LSM (not shown). Furthermore FIG. 11 illustrates the machine frame MFR around which the machine is build and a support base for exposure system energy chain SBEC.

The present invention exhibits notable and unexpected advantages for the infra red powder sintering of materials, whereby large surfaces can be rapidly treated with high precision

1-75. (canceled)

76. Apparatus for producing a three-dimensional object from a light-sensitive material, said apparatus comprising:
an exposure system (ES) with an illumination source,
a scanning bar to which the exposure system (ES) is mounted,
a control unit (CU),
whereby said exposure system (ES) comprises:
at least one spatial light modulator (SLM) with a plurality of individually controllable light modulators (LM),
input optics (IO) optically coupled to said at least one spatial light modulator (SLM),
output optics (OO) optically coupled to said at least one spatial light modulator (SLM),
wherein said input optics (IO) and output optics (OO) facilitates transmission of light emitted from said illumination source via said individually controllable light modulators (LM) of said spatial light modulator (SLM) to an illumination area (IA),
wherein said spatial light modulator (SLM) enables an establishment of a pattern of the light transmitted through said input optics (IO), according to control signals originating from said control unit (CU),
wherein said output optics (OO) enable focusing of the pattern of light from said at least one spatial light modulator (SLM) on an illumination area (IA),
wherein the distance d between the output optics (OO) and the illumination area (IA) is between 0.5 and 20 mm.

77. Apparatus for producing a three-dimensional object from a light-sensitive material, said apparatus comprising:
an exposure system (ES) with an illumination source,
a scanning bar to which the exposure system (ES) is mounted,
a control unit (CU),
whereby said exposure system (ES) comprises:
at least one spatial light modulator (SLM) with a plurality of individually controllable light modulators (LM),
input optics (IO) optically coupled to said at least one spatial light modulator (SLM),
output optics (OO) optically coupled to said at least one spatial light modulator (SLM),
wherein said input optics (IO) and output optics (OO) facilitates transmission of light emitted from said illumination source as at least two light beams via said individually controllable light modulators (LM) of said spatial light modulator (SLM) to an illumination area (IA),
wherein said spatial light modulator (SLM) enables an establishment of a pattern of the light transmitted through said input optics (IO), according to control signals originating from said control unit (CU),
wherein said output optics (OO) enable focusing of the pattern of light from said at least one spatial light modulator (SLM) on an illumination area (IA),
wherein the distance d between the output optics (OO) and the illumination area (IA) is between 0.5 and 20 mm.

78. Apparatus according to claim 76 wherein said output optics (OO) comprises at least one micro-lens and said output optics (OO) has such characteristics that it is able to focus the pattern of light on the illumination area (IA) in such a way that the focusing distance d between the output optics (OO) and the illumination area (IA) is between 0.5 and 20 mm.

79. Apparatus according to claim 78, wherein said exposure system comprises at least two micro-lenses adapted to focus the light in a distance d between 1 and 10 mm from said output optics.

80. Apparatus according to claim 78 wherein the total number of micro-lenses corresponds to at least the total number of light modulators multiplied by the number of micro-lens layers.

81. Apparatus according to claim 76 wherein said exposure system comprises an array of micro-lenses with the total number of micro-lenses being above 200.

82. Apparatus according to claim 81 wherein said at least one micro-lens has a curvature radius between 300 μm and 400 μm.

83. Apparatus according to claim 82, wherein said at least one micro-lens exhibits a back focal length of above 400 μm.

84. Apparatus according to claim 78 wherein said at least one micro-lens focuses the light sent through said at least one micro-lens into a beam spot with a diameter of less than 200 μm at a focusing distance d from the output optics between 0.5 mm and 20 mm.

85. Apparatus according to claim 76 wherein said apparatus comprises a vat comprising light-sensitive material in an amount so that the surface of said light-sensitive material substantially coincides with said illumination area.

86. Apparatus according to claim 85, wherein the minimum distance between said output optics and said surface of said light-sensitive material is between 1 mm and 10 mm.

87. Apparatus for producing a three-dimensional object from a light-sensitive material, said apparatus comprising:
an exposure system (ES) with an illumination source,
a scanning bar to which the exposure system (ES) is mounted,
a control unit (CU),
whereby said exposure system (ES) comprises:
at least one spatial light modulator (SLM) with a plurality of individually controllable light modulators (LM),
input optics (IO) optically coupled to said at least one spatial light modulator (SLM),
output optics (OO) optically coupled to said at least one spatial light modulator (SLM),
wherein said input optics (IO) and output optics (OO) facilitates transmission of light emitted from said illumination source via said individually controllable light modulators (LM) of said spatial light modulator (SLM) to an illumination area (IA),
wherein said spatial light modulator (SLM) enables an establishment of a pattern of the light transmitted through said input optics (IO), according to control signals originating from said control unit (CU),
wherein said output optics (OO) enable focusing of the pattern of light from said at least one spatial light modulator (SLM) on an illumination area (IA),
wherein said apparatus comprises at least one releasable protective window (PW) between said output optics (OO) and said illumination area (IA),
wherein said at least one protective window is positioned at a distance of less than 10 mm from said output optics.

88. Apparatus according to claim 87, wherein said at least one protective window is part of a replaceable module (RM).

89. Apparatus according to claim 87 wherein the focusing distance d is less than 10 mm.

90. Apparatus according to claim 88 wherein said replaceable module is mounted on said exposure system.

91. Apparatus for producing a three-dimensional object from a light-sensitive material, said apparatus comprising:
an exposure system (ES) with an illumination source,
a scanning bar to which the exposure system (ES) is mounted,
a control unit (CU),
whereby said exposure system (ES) comprises:
at least one spatial light modulator (SLM) with a plurality of individually controllable light modulators (LM),
input optics (IO) optically coupled to said at least one spatial light modulator (SLM),
output optics (OO) optically coupled to said at least one spatial light modulator (SLM),
wherein said input optics (IO) and output optics (OO) facilitates transmission of light emitted from said illumination source via said individually controllable light modulators (LM) of said spatial light modulator (SLM) to an illumination area (IA),
wherein said spatial light modulator (SLM) enables an establishment of a pattern of the light transmitted through said input optics (IO), according to control signals originating from said control unit (CU),
wherein said output optics (OO) enable focusing of the pattern of light from said at least one spatial light modulator (SLM) on an illumination area (IA),
wherein said apparatus comprises at least one collision-preventing detection system (LBa, LBb, HSa, HSb) for detecting obstacles between the illumination area (IA) and the output optics (OO),
wherein said collision-preventing detection system comprises at least one light emitter (LD) and at least one light sensor (PD) capable of providing at least one collision-preventing light beam,
wherein the diameter of said collision-preventing light beam is less than 2 mm.

92. Apparatus according to claim 91, wherein said collision-preventing detection system comprises at least two light emitters and at least two light sensors capable of providing at least two collision-preventing light beams.

93. Apparatus according to claim 91 wherein said at least one collision-preventing detection system is attached to said scanning bar.

94. Apparatus according to claim 91 wherein said collision-preventing detection system is such that said at least one collision-preventing light beam is capable of propagating in front of and/or behind the scanning bar in a direction perpendicular to the moving direction of the scanning bar.

95. Apparatus according to claim 91 wherein said collision-preventing detection system comprises at least one directional-changing means (PRa, PRb).

96. Apparatus according to claim 76, wherein said exposure system comprises light-emitting diodes.

97. Method of manufacturing a three-dimensional object from a light-sensitive material comprising illuminating the light-sensitive material using the apparatus according to claim 76 to cure the light-sensitive material.

98. Method of manufacturing three-dimensional objects from a light-sensitive material according to claim 97 wherein the apparatus further comprises a collision-preventing detection system, and
wherein a lowering of the intensity of the signal from the collision-preventing detection system of more than 5% results in a signal stopping the movement of the scanning bar.

99. Three-dimensional object produced by the method according to claim 97.
